(19) United States
(12) Patent Application Publication
(10) Pub. No.: US 2012/0176425 A1
(43) Pub. Date: Jul. 12, 2012

(54) SOURCE DRIVING APPARATUS AND DRIVING METHOD THEREOF

(75) Inventor: Shao-Ping Hung, Hsinchu City (TW)

(73) Assignee: RAYDIUM SEMICONDUCTOR CORPORATION, Hsinchu (TW)

(21) Appl. No.: 13/425,154

(22) Filed: Mar. 20, 2012

Related U.S. Application Data
(62) Division of application No. 12/355,838, filed on Jan. 19, 2009.

(30) Foreign Application Priority Data
Jul. 30, 2008 (TW) 97128902

(51) Int. Cl. G09G 5/10

(52) U.S. Cl. 345/690

(57) ABSTRACT

A source driving apparatus and a driving method thereof are provided. The source driving apparatus comprises an encoder and a source driver. The encoder encodes a video data with n bits to the encoded data according to encoding rules, such that the bit change in two adjacent grays is less than n. The source driver outputs a pixel voltage corresponding to the video data according to the encoded data.

This application is a divisional application of co-pending U.S. application Ser. No. 12/355,838, filed Jan. 19, 2009, which claims the benefit of Taiwan application Serial No. 97128902, filed Jul. 30, 2008. These related applications are incorporated herein by reference in their entirety.

### BACKGROUND OF THE INVENTION

1. Field of the Invention

The invention relates in general to a source driving apparatus and a driving method thereof, and more particularly to a source driving apparatus capable of reducing noise and a driving method thereof.

2. Description of the Related Art

Referring to FIG. 1, a block diagram of a source driver is shown. The source driver 10 comprises a shift register 110, a first column latch 120, a second column latch 130, a level shifter 140 and a digital/analog converter 150. The shift register 110 controls the first column latch 120 to sequentially receive the video data. After the first column latch 120 finishes data receiving, the first column latch 120 outputs the stored video data to the second column latch 130. After the level of the video data stored in the second column latch 130 is changed by the level shifter 140, the video data is outputted to the digital/analog converter 150 and a corresponding pixel voltage is outputted to drive the display panel.

However, if the bit change in the level shifter, the first column latch and the second column latch is large, a large transient current will be required instantaneously and noises will be generated. Consequently, the generated noises will affect the grounding level and cause bias to the level of the voltage outputted from the digital/analog converter. As the liquid crystal display denotes different gray levels by way of voltage difference, the displayed gray level will be incorrect if voltage difference is incorrect. Particularly, the adjacent gray levels are easily noticed by the viewer.

Referring to FIG. 2, a digital/analog converter is shown. Let 6 bits be taken for example. The digital/analog converter 150 comprises reference voltage input ends S0 to S63 and the input ends of the data bits D0 to D5. The reference voltage input ends S0 to S63 respectively receive the reference voltages V0 to V63 and selectively output one of the reference voltages V0 to V63 according to the data bits D0 to D5. For example, the data bits D5 to D0 corresponding to the data “31” is 011111. If the data bits D5 to D0 are 011111, the digital/analog converter 150 outputs the reference voltage V31, and the data bits D5 to D0 corresponding to the data “32” is 100000. If the data bits D5 to D0 are 100000, the digital/analog converter 150 outputs the reference voltage V32.

When the data bits D5 to D0 change to 100000 from 011111, 6 bits are changed, and there will be large bit change in the level shifter, the first column latch and the second column latch. As the bit change is large, a large transient current will be needed instantaneously, and noises will be generated. The generated noises make the reference voltage V32 which was originally greater than the reference voltage V31 become less than the reference voltage V31. Or, the noises make the reference voltage V32 which was originally less than the reference voltage V31 become greater than the reference voltage V31. Therefore, unevenness will occur at where the bit change is large and severely affect display quality.

### SUMMARY OF THE INVENTION

The invention is directed to a source driving apparatus and a driving method thereof. By way of appropriate encoding, noises, which would otherwise occur when the bit change in adjacent gray levels is too large, are avoided, hence effectively enhancing display quality.

According to a first aspect of the present invention, a source driving apparatus is provided. The source driver comprises an encoder and a source driver. The encoder encodes a video data with n bits to the encoded data according to encoding rules, such that the bit change in two adjacent grays is less than n. The source driver outputs a pixel voltage corresponding to the video data according to the encoded data.

According to a second aspect of the present invention, a method of driving source driving apparatus is provided. The driving method comprises the following steps. A video data with n bits is encoded to the encoded data according to encoding rules, such that the bit change in two adjacent grays is less than n. A pixel voltage corresponding to the video data is outputted according to the encoded data.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a block diagram of a source driver;

FIG. 2 (Prior Art) shows a digital/analog converter;

FIG. 3 shows a source driving apparatus according to a preferred embodiment of the invention;

FIG. 4 shows an encoding table according to a first encoding rule;

FIG. 5 shows an encoding table according to a second encoding rule;

FIG. 6 shows an encoding table according to a third encoding rule;

FIG. 7 shows a block diagram of a source driving apparatus and a reference voltage generating circuit;

FIG. 8 shows a block diagram of a reference voltage generating circuit, a voltage correspondence conversion circuit and a digital/analog converter; and

FIG. 9 shows a flowchart of a method for driving source driving apparatus according to a preferred embodiment of the invention.

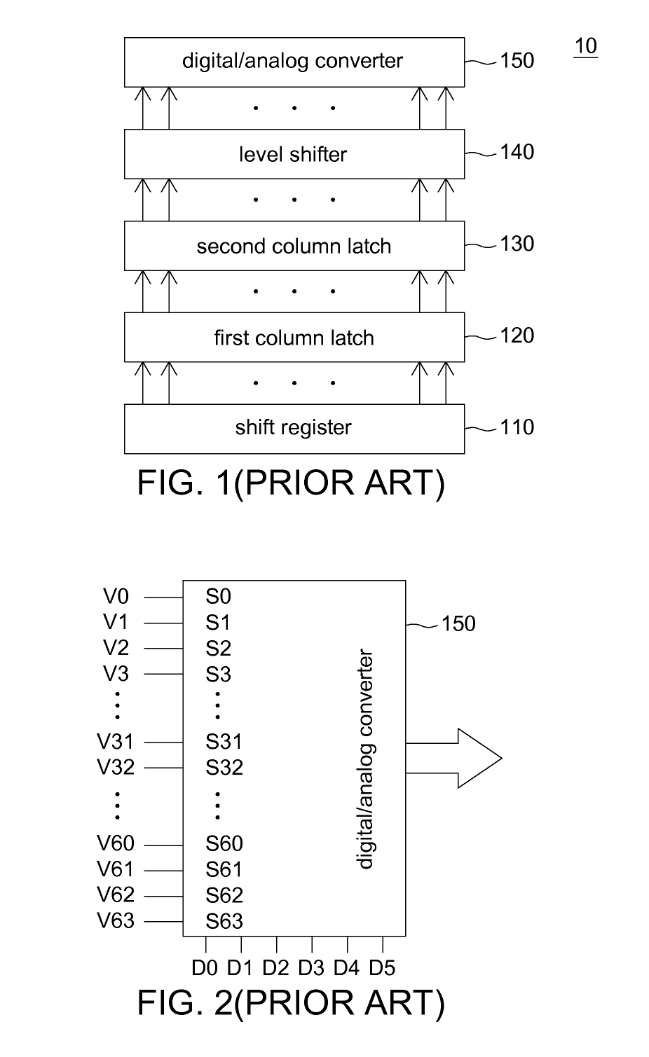

### DETAILED DESCRIPTION OF THE INVENTION

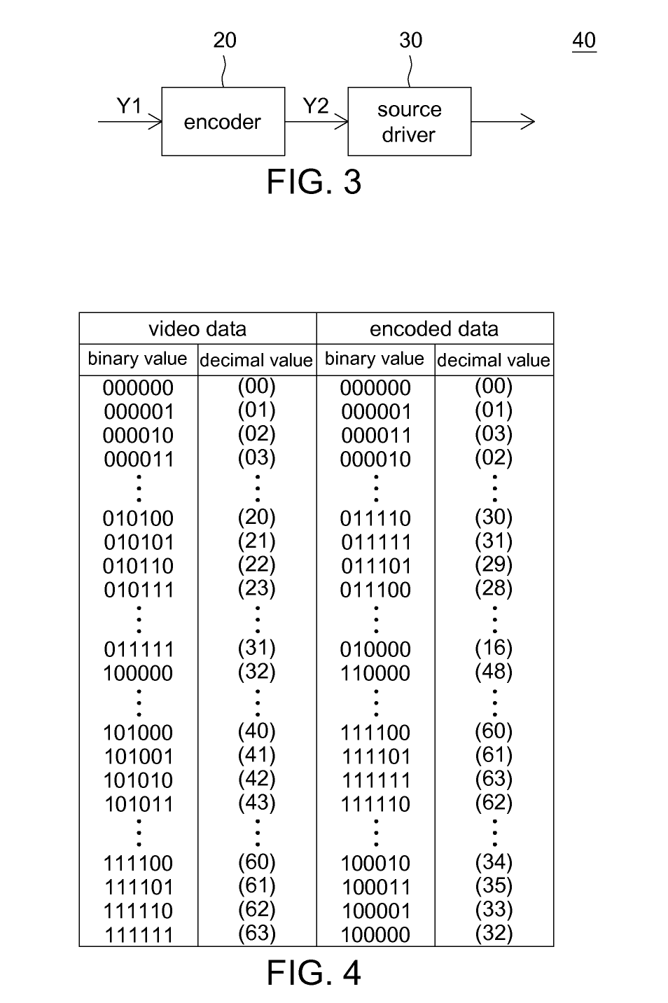

Referring to FIG. 3, a source driving apparatus according to a preferred embodiment of the invention is shown. The source driving apparatus 40 comprises an encoder 20 and a source driver 30. The encoder 20 encodes the video data with n bits Y1 to an encoded data Y2 according to a suitable encoding rule, such that the bit change in two adjacent grays of the video data Y1 is less than n. The source driver 30 outputs a pixel voltage corresponding to the video data Y1 according to the encoded data Y2.

Referring to FIG. 4, an encoding table according to a first encoding rule is shown. The above encoding rule is gray code for example. Let 6 bits be taken for example. The video data Y1 is encoded to an encoded data Y2 by the encoder 20 according to the gray code. If the decimal value of the video data Y1 is “31” before encoding, the corresponding binary value is 011111, and the corresponding binary value of the encoded data Y2 is 010000. If the decimal value of the video data Y1 is “32” before encoding, the corresponding binary value is 100000, and the corresponding binary value of the encoded data Y2 is 110000. If the binary value of the video data Y1 changes to 100000 from 011111, 6 bits are changed. As the binary value of the encoded data Y2 changes to 110000 from 010000, only 1 bit is changed. Thus, the bit change in adjacent gray levels will be limited, and there is no need for a large transient current, hence avoiding undue interference of noises.

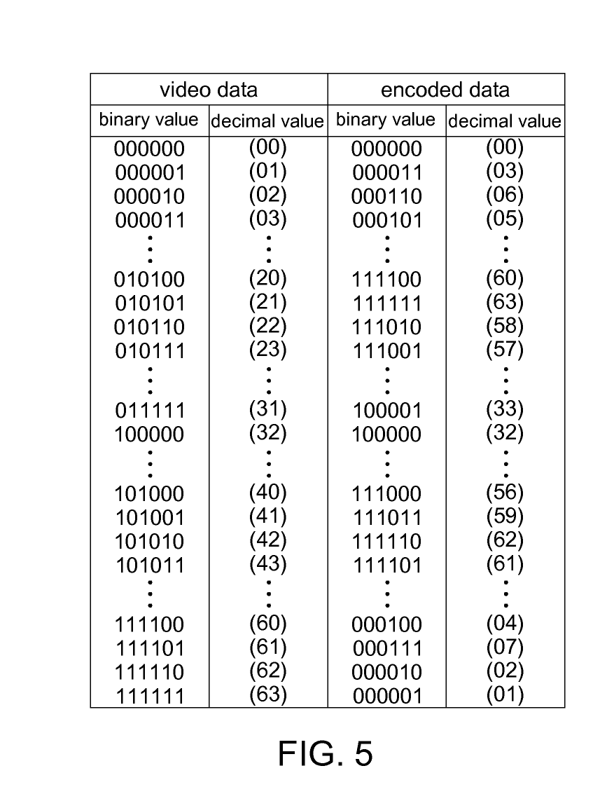

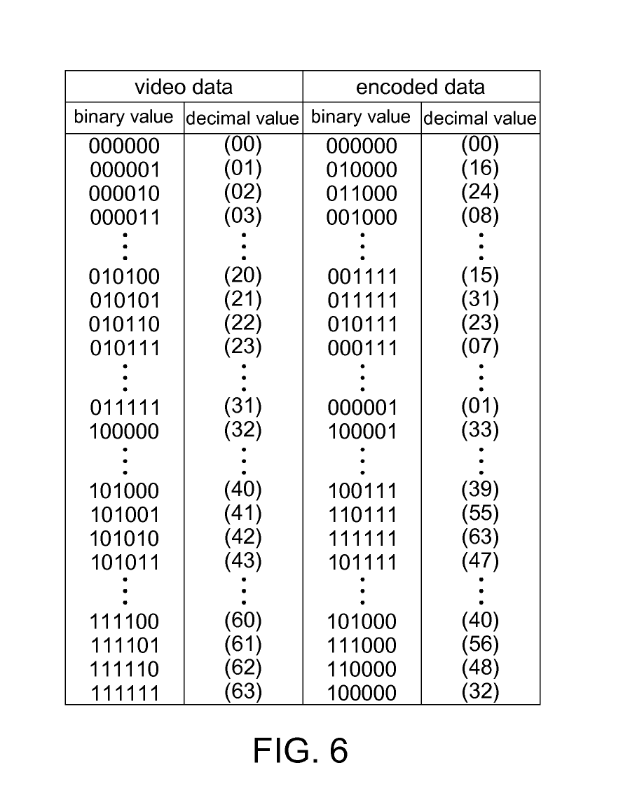

Referring to FIG. 5 and FIG. 6. FIG. 5 shows an encoding table according to a second encoding rule. FIG. 6 shows an encoding table according to a third encoding rule. In addition to the above encoding rule of gray code, the encoder 20 of FIG. 3 can also encode the video data Y1 according to the encoding rules of FIG. 5 and FIG. 6, and the bit change in adjacent gray levels will be limited.

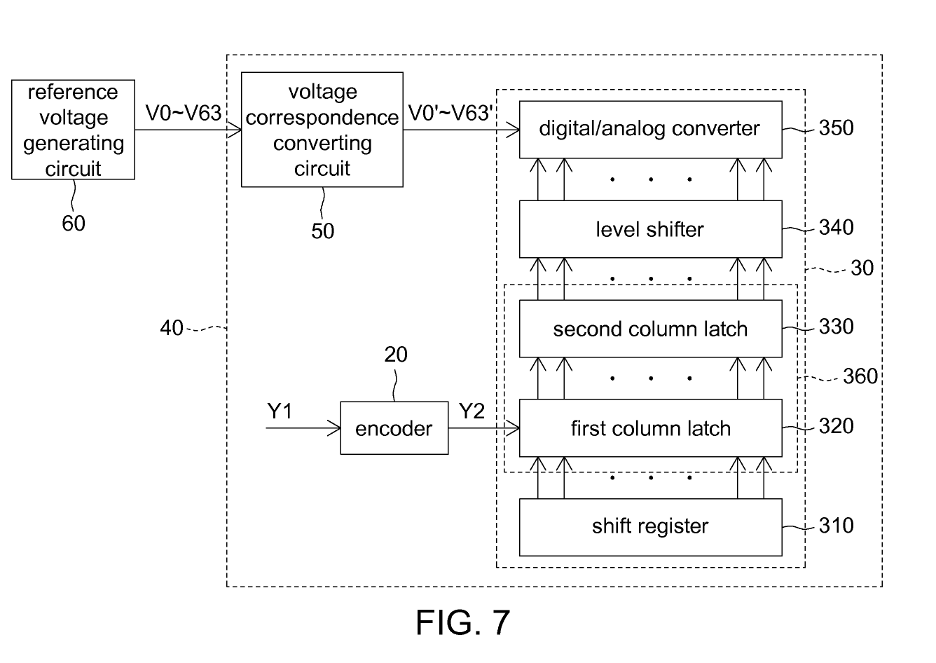

Referring to FIG. 7, a block diagram of a source driving apparatus and a reference voltage generating circuit is shown. The source driving apparatus 40 further comprises a voltage correspondence conversion circuit 50 in addition to the encoder 20 and the source driver 30 disclosed above. The source driver 30 comprises a shift register 310, a latch unit 360, a level shifter 340 and a digital/analog converter 350. The shift register 310 controls the latch unit 360 to sequentially receive the encoded data Y2 and latch the encoded data Y2. The latch unit 360 comprises a first column latch 320 and a second column latch 330. The first column latch 320 receives the encoded data Y2 outputted from the encoder 20 and latches the encoded data Y2. The second column latch 330 latches the encoded data Y2 outputted from the first column latch 320. The level shifter 340 changes the level of the encoded data Y2 and then outputs the encoded data Y2. The digital/analog converter 350 outputs the pixel voltage according to the encoded data Y2 outputted from the level shifter 340.

The voltage correspondence conversion circuit 50 again determines the connection between the digital/analog converter 350 and the reference voltage generating circuit 60 according to the above encoding rules, such that the digital/analog converter 350 outputs the pixel voltage corresponding to the video data Y1 according to the encoded data Y2. That is, the present embodiment of the invention can achieve decoding without using any additional decoder by appropriately determining the connection relationship between the digital/analog converter 350 and the reference voltage generating circuit 60.

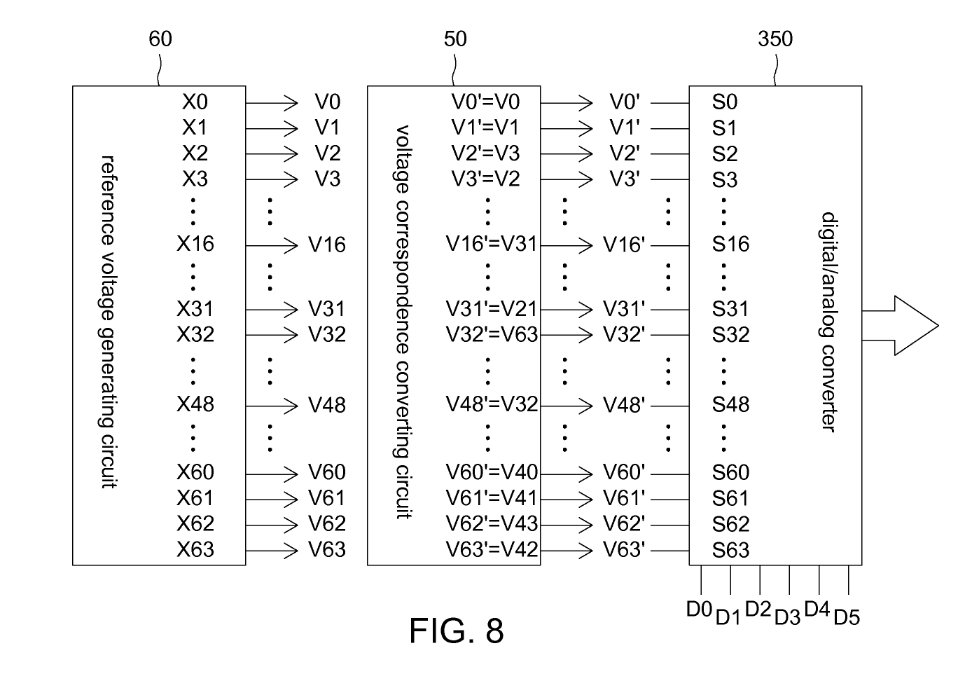

Referring to FIG. 8, a block diagram of a reference voltage generating circuit, a voltage correspondence conversion circuit and a digital/analog converter is shown. Let 6 bits be taken for example. The digital/analog converter 350 comprises 64 reference voltage input ends S0 to S63. The reference voltage input ends S0 to S63 respectively receive 64 reference voltages V0′ to V63′ and selectively output one of the reference voltages V0′ to V63′ according to 6 data bits D0 to D5. The reference voltage generating circuit 60 comprises 64 reference voltage output ends X0 to X63 for respectively outputting 64 reference voltages V0 to V63. The voltage correspondence conversion circuit 50 determines the connection between the reference voltage input ends S1 to S63 and the reference voltage output ends X0 to X63 according to the above encoding rules such that the digital/analog converter 350 outputs the pixel voltage corresponding to the video data Y1 according to the encoded data Y2.

Let the gray code be taken for example. If the decimal value of the video data Y1 is “31” before encoding, the decimal value of the encoded data Y2 changes to “16” after encoding. The voltage correspondence conversion circuit 50 is electrically connected to the reference voltage output end X31 to the reference voltage input end S16 according to the encoding rule of gray code, such that the reference voltage V31 is inputted to the reference voltage input end S16 of the digital/analog converter 350 via the voltage correspondence conversion circuit 50. If the decimal value of the encoded data Y2 is “16”, the digital/analog converter 350 output the reference voltage V31 according to the data “16” to display the gray level value corresponding to the decimal value of the video data Y1 being “31”.

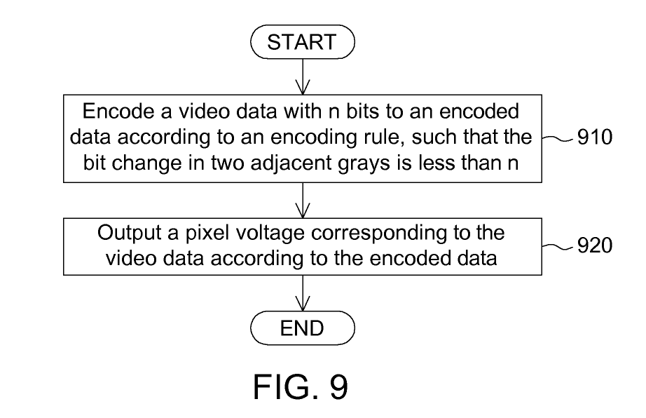

Referring to FIG. 9, a flowchart of a method for driving source driving apparatus according to a preferred embodiment of the invention is shown. The driving method can be applied to the source driving apparatus 40 of the above embodiments. The driving method comprises the following steps. Firstly, the method begins at step 910, the encoder 20 encodes the video data with n bits Y1 to the encoded data Y2 according to an encoding rule such that the bit change in two adjacent grays is less than n. Next, the method proceeds to step 920, the source driver 30 outputs a pixel voltage corresponding to the video data Y1 according to the encoded data Y2.

By way of appropriate encoding, the source driving apparatus and the driving method thereof disclosed in the above embodiments of the invention avoid noises occurring if the bit change in adjacent gray levels is too large, hence effectively enhancing display quality.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for driving source driving apparatus, the method comprising:
(a) encoding a video data with n bits to an encoded data according to an encoding rule, such that the bit change in two adjacent grays is less than n; and
(b) outputting a pixel voltage corresponding to the video data according to the encoded data.

2. The driving method according to claim 1, wherein the step (b) comprises:
(b1) latching the encoded data;
(b2) changing the level of the encoded data and outputting the encoded data; and
(b3) outputting the pixel voltage according to the encoded data whose level has changed.

3. The driving method according to claim 1, wherein the source driving apparatus at least comprises a digital/analog converter, the driving method further comprises:
(c) determining the connection between the digital/analog converter and a reference voltage generating circuit according to the encoding rule, such that the digital/analog converter outputs the pixel voltage corresponding to the video data according to the encoded data.

4. The driving method according to claim 1, wherein the digital/analog converter comprises a plurality of reference voltage input ends, the reference voltage generating circuit comprises a plurality of reference voltage output ends, and in the step (c), the connection between the reference voltage input ends and the reference voltage output ends is determined according to the encoding rule, such that the source driver outputs the pixel voltage corresponding to the video data according to the encoded data.
